(19) United States
(12) Patent Application Publication
(10) Pub. No.: US 2024/0413388 A1
(43) Pub. Date: Dec. 12, 2024

(54) SULFIDE SOLID ELECTROLYTE, METHOD FOR PRODUCING SULFIDE SOLID ELECTROLYTE, AND ALL-SOLID-STATE BATTERY

(71) Applicant: TOYOTA JIDOSHA KABUSHIKI KAISHA, Toyota-shi (JP)

(72) Inventors: Koji KAWAMOTO, Miyoshi-shi (JP); Daiki BITO, Nishinomiya-shi (JP)

(73) Assignee: TOYOTA JIDOSHA KABUSHIKI KAISHA, Toyota-shi (JP)

(21) Appl. No.: 18/732,806

(22) Filed: Jun. 4, 2024

(30) Foreign Application Priority Data
Jun. 9, 2023 (JP) 2023-095415

(51) Int. Cl. H01M 10/0562; C03B 19/10; C03B 32/00; C03C 3/32; C03C 4/14

(52) U.S. Cl. CPC H01M 10/0562; C03B 19/1005; C03B 32/00; C03C 3/321; C03C 4/14; C03B 2201/86; C03C 2204/00; H01M 2300/0068

(57) ABSTRACT

A sulfide solid electrolyte for use in an all-solid-state battery has a composition represented by (100−x) [yLi₂S·(1−y)P₂S₅]·xLiBH₄. In the formula, x is a value satisfying 50<x<75, and y is a value satisfying 0.72≤y≤0.78. The sulfide solid electrolyte has an ionic conductivity of 5.0 mS/cm or more at 25° C.

### CROSS-REFERENCE TO RELATED APPLICATION

This application claims priority to Japanese Patent Application No. 2023-095415 filed on Jun. 9, 2023, incorporated herein by reference in its entirety.

### BACKGROUND

### 1. Technical Field

The present disclosure relates to sulfide solid electrolytes, methods for producing a sulfide solid electrolyte, and all-solid-state batteries.

### 2. Description of Related Art

An all-solid-state battery is a battery having a solid electrolyte layer between a positive electrode active material layer and a negative electrode active material layer. All-solid-state batteries are advantageous in that a safety device can be more easily simplified compared to liquid batteries having an electrolyte solution containing a flammable organic solvent. A sulfide solid electrolyte is known as a solid electrolyte for use in all-solid-state batteries.

For example, WO2016/103894 discloses a method for producing an ionic conductor (sulfide solid electrolyte). This method includes: mixing LiBH₄ and P₂S₅ at a molar ratio of LiBH₄:P₂S₅=x:(1−x) (where x is more than 0.85 and 0.98 or less) to obtain a mixture; and heat treating the mixture. WO2016/103894 also discloses an ion conductor (sulfide solid electrolyte) produced by this method.

Mechanochemically Prepared Li₂S—P₂S₅—LiBH₄ Solid Electrolytes with an Argyrodite Structure (ACS Omega 2018, 3, 5453 5458) discloses sulfide solid electrolytes represented by (100−x)(0.75Li₂S·0.25P₂S₅)·xLiBH₄.

### SUMMARY

From the viewpoint of improving battery performance, there is a demand for solid electrolytes with good ion conducting properties.

The present disclosure was made in view of the above circumstances, and it is a primary object of the present disclosure to provide a sulfide solid electrolyte with good ion conducting properties.

(1)

A sulfide solid electrolyte for use in an all-solid-state battery has a composition represented by

(100−x)[yLi₂S·(1−y)P₂S₅]·xLiBH₄,

where x satisfies 50<x<75, and y satisfies 0.72≤y≤0.78.
An ionic conductivity of the sulfide solid electrolyte at 25° C. is 5.0 mS/cm or more.
(2)

In the sulfide solid electrolyte according to (1), the ionic conductivity may be 8.0 mS/cm or more.

(3)

In the sulfide solid electrolyte according to (1) or (2), in an X-ray diffraction measurement using a CuKα ray, the sulfide solid electrolyte may have one peak in a range where 2θ is 13° or more and 16° or less.

(4)

A method for producing the sulfide solid electrolyte according to any one of (1) to (3) includes
a first mechanical milling step of mechanically milling a mixture containing Li₂S and P₂S₅ to obtain a first sulfide glass; and
a second mechanical milling step of adding LiBH₄ to the first sulfide glass and mechanically milling a mixture of the first sulfide glass and LiBH₄ to obtain a second sulfide glass.

In the first mechanical milling step and the second mechanical milling step, the mechanical milling is performed in such a manner that gravity Gn1 calculated by the following expression (1) is equal to or greater than 6 G:

$$Gn 1 = [ rs - \{ rp 1 \cdot 〈 \frac{rp 1}{rs} \cdot {( 1 + iw )}^{2} 〉 \} ] \cdot \frac{{( 2 \cdot π \cdot \frac{rpm}{60} )}^{2}}{9.81} \qquad ( 1 )$$

where rs represents a revolution radius, rp1 represents a radius of a container used in the mechanical milling, iw represents a rotation-to-revolution ratio, x represents a ratio of a circumference of a circle to a diameter of the circle, and rpm represents a number of revolutions per minute.
(5)

In the method according to (4),
the gravity Gn1 may be equal to or greater than 15 G.
   (6)

The method according to (4) or (5) may further include
a heat treatment step of heat treating the sulfide glass.
   A temperature of the heat treatment may be 190° C. or less.
   (7)

An all-solid-state battery includes a positive electrode active material layer, a negative electrode active material layer, and a solid electrolyte layer disposed between the positive electrode active material layer and the negative electrode active material layer. At least one of the following layers contains the sulfide solid electrolyte according to any one of (1) to (3): the positive electrode active material layer, the negative electrode active material layer, and the solid electrolyte layer.

The present disclosure advantageously provides a sulfide solid electrolyte with good ion conducting properties.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flow diagram illustrating a method for producing a sulfide solid electrolyte according to the present disclosure;

FIG. 2 is a schematic cross-sectional view illustrating an all-solid-state battery in the present disclosure;

FIG. 3 is a graph showing measurement results of ionic conductivity in Examples;

FIG. 4A is a graph showing the measurement results of an X-ray diffraction pattern according to an embodiment of the present disclosure;

FIG. 4B is a graph showing the measurement results of an X-ray diffraction pattern according to an embodiment of the present disclosure;

FIG. 5 is a graph showing a measurement of a discharge capacity retention ratio in an embodiment; and

FIG. 6 is a graph showing measurement results of ionic conductivity in Examples.

### DETAILED DESCRIPTION OF EMBODIMENTS

Hereinafter, a sulfide solid electrolyte, a method for producing a sulfide solid electrolyte, and an all-solid-state battery according to the present disclosure will be described in detail.

### A. Sulfide Solid Electrolyte

The sulfide solid electrolyte in the present disclosure is a sulfide solid electrolyte used in an all-solid-state battery. The sulfide solid electrolyte has a composition represented by (100−x)[yLi₂S·(1−y)P₂S₅]·xLiBH₄. In the formula, x satisfies 50<x<75. y satisfies 0.72≤y≤0.78. The ionic conductivity of the sulfide solid electrolyte at 25° C. is 5.0 mS/cm or more.

In the present disclosure, the sulfide solid electrolyte has good ion conducting properties because it has an ionic conductivity of 5.0 mS/cm or more in a predetermined composition range.

Here, the sulfide solid electrolyte disclosed in the above-mentioned WO 2016/103894 does not use Li₂S, and the ionic conductivity is at most 2.0 mS/cm (measured at 27° C.). In addition, the ionic conductivity of the sulfide solid electrolyte disclosed in Mechanochemically Prepared Li₂S—P₂S₅—LiBH₄ Solid Electrolytes with an Argyrodite Structure (ACS Omega 2018, 3, 5453 5458) is at most 1.8 mS/cm (measured 25° C.). On the other hand, the sulfide solid electrolyte exhibits an ionic conductivity of 5.0 mS/cm or higher in a predetermined range. The sulfide solid electrolyte of the present disclosure has significantly better ion conducting properties than the sulfide solid electrolyte in the document mentioned above.

Sulfide solid electrolyte in the present disclosure has a composition represented by (100−x)[yLi₂S·(1−y)P₂S₅]·xLiBH₄. In the above composition, x is a number greater than 50, may be a number greater than or equal to 52, may be a number greater than or equal to 55, or may be a number greater than or equal to 60. On the other hand, x is a number less than 75, may be 70 or less number, may be 67 or less number, may be 65 or less number, it may be 63 or less number. In the above composition, y is a number of 0.72 or more, and may be a number of 0.73 or more. On the other hand, y is a number of 0.78 or less, and may be a number of 0.75 or less. In particular, y is preferably a number in which Li₃PS₄ configuration is mainly obtained in the first mechanical milling step that will be described later. In particular, when y is 0.75, that is, the ratio of Li₂S to P₂S₅ is preferably 75:25.

The sulfide solid electrolyte of the present disclosure has an ionic conductivity of 5.0 mS/cm or higher at 25° C. The ionic conductivity may be greater than or equal to 5.3 mS/cm, greater than or equal to 5.5 mS/cm, greater than or equal to 6.0 mS/cm, greater than or equal to 8.0 mS/cm, or greater than or equal to 10.0 mS/cm.

The sulfide solid electrolyte in the present disclosure may be sulfide glass or crystalline sulfide glass (glass ceramics). In addition, the sulfide solid electrolyte in the present disclosure may be a crystalline material obtained by a solid phase reaction treatment on a mixture.

Sulfide glasses can be obtained by amorphous treating mixtures comprising Li₂S, P₂S₅, and LiBH₄. Examples of amorphous processing include mechanical milling. Mechanical milling will be described later.

The crystallized sulfide glass can be obtained, for example, by heat treating the sulfide glass at a temperature equal to or higher than the crystallization temperature.

The sulfide solid electrolyte in the present disclosure preferably has one peak in the range where 2θ is 13° or more and 16° or less in an X-ray diffraction measurement using CuKα rays. The phrase “has one peak in the range where 2θ is 13° or more and 16° or less” means that one peak top is observed in the range where 2θ is 13° or more and 16° or less. When a shoulder peak is observed, the shoulder peak itself is regarded as one peak.

The sulfide solid electrolyte in the present disclosure is used in an all-solid-state battery. The all-solid-state battery will be described later.

### B. Method for Producing Sulfide Solid Electrolyte

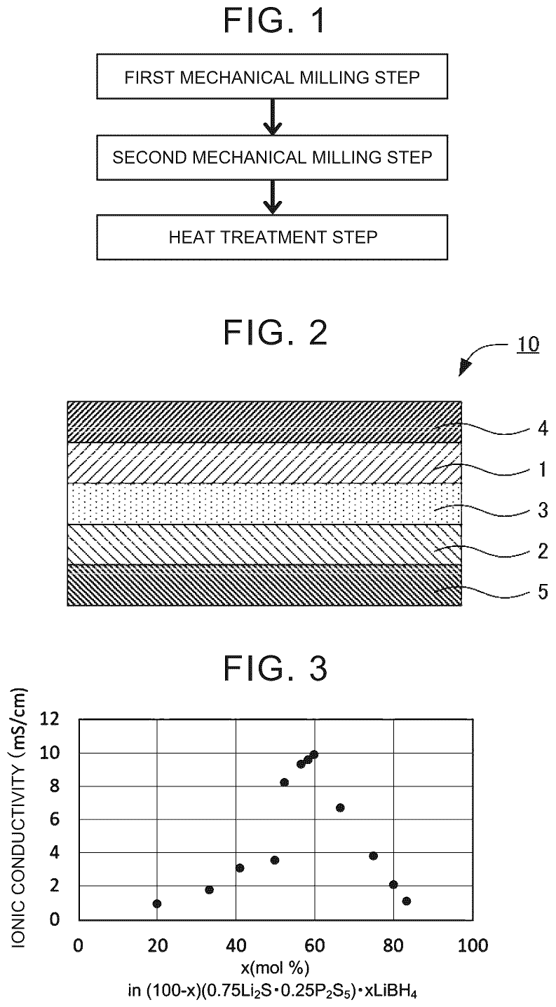

FIG. 1 is a flowchart illustrating a method for producing a sulfide solid electrolyte according to the present disclosure. The method for producing a sulfide solid electrolyte according to the present disclosure is the method for producing a sulfide solid electrolyte described above. As shown in FIG. 1, the process for producing a sulfide solid electrolyte according to the present disclosure includes at least a predetermined first mechanical milling step and a predetermined second mechanical milling step.

### 1. First Mechanical Milling Step

The first mechanical milling step in the present disclosure is a step of mechanically milling a mixture comprising Li₂S and P₂S₅ to obtain a first sulfide glass.

The ratio of Li₂S and P₂S₅ in the mixture is not particularly limited as long as the above-described sulfide solid electrolyte can be obtained. That is, the ratio (molar ratio) of Li₂S to P₂S₅ is y: 1−y (0.72≤y≤0.78) in the above composition formula.

In the first mechanical milling step, mechanical milling is performed so that the gravity Gn1 calculated from the expression (1) below is equal to or greater than 6 G. The expression (1) is an expression for converting the force applied in the mechanical milling into gravity. Gn1 can also be regarded as gravitational accelerations. By performing mechanical milling so as to be equal to or higher than 6G in terms of gravitational force, it is possible to obtain a first sulfide glass in which a Li₃PS₄ skeleton is satisfactorily formed. By using such a first sulfide glass, a sulfide solid electrolyte with a good ionic conductivity can be obtained.

$$Gn 1 = [ rs - \{ rp 1 \cdot 〈 \frac{rp 1}{rs} \cdot {( 1 + iw )}^{2} 〉 \} ] \cdot \frac{{( 2 \cdot π \cdot \frac{rpm}{60} )}^{2}}{9.81} \qquad ( 1 )$$

In the expression (1), rs represents a revolution radius, rp1 represents the radius of a container used in the mechanical milling, iw represents the rotation-to-revolution ratio, π represents the ratio of the circumference of a circle to its diameter, and rpm represents the number of revolutions per minute.

Gn1 calculated from the expression (1) may be 8 G or more, may be 10 G or more, may be 15 G or more, or may be 18 G or more. On the other hand, Gn1 may be, for example, less than or equal to 25 G, less than or equal to 22 G, or less than or equal to 20 G.

The mechanical milling time in the first mechanical milling step is not particularly limited, and is, for example, 5 hours or more and 24 hours or less.

The type of mechanical milling may be wet mechanical milling or may be dry mechanical milling. Mechanical milling can also include, for example, a ball mill such as a planetary ball mill.

### 2. Second Mechanical Milling Step

The second mechanical milling step is a step of adding LiBH₄ to the first sulfide glass and performing mechanical milling to obtain a second sulfide glass.

The ratio of the first sulfide glass to LiBH₄ is not particularly limited as long as the above sulfide solid electrolyte can be obtained. That is, the ratio (molar ratio) between the first sulfide glass and LiBH₄ is 100−x:x (50<x<75) in the above compositional formula.

In the second mechanical milling step, mechanical milling is performed so that the gravity Gn1 calculated from the above expression (1) is equal to or greater than 6G. The expression (1) and Gn1 are as described above. In the first mechanical milling step and the second mechanical milling step, Gn1 may be the same or different.

The mechanical milling time and the type of mechanical milling in the second mechanical milling step are the same as those in the first mechanical milling step described above.

### 3. Heat Treatment Step

The method for producing a sulfide solid electrolyte according to the present disclosure may include a heat treatment step of heat treating the sulfide glass. The temperature of the heat treatment is 190° C. or less.

If the heat treatment temperature is too high, it is presumed that a different phase may be formed in the obtained sulfide solid electrolyte. On the other hand, it is presumed that by setting the heat treatment temperature to 190° C. or less, formation of a different phase is suppressed, and a sulfide solid electrolyte (sulfide solid electrolyte having good crystallinity) with a better ionic conductivity can be obtained. This is presumed to be because the hydride (LiBH₄) used in the sulfide solid electrolyte of the present disclosure undergoes a phase transition at around 400 K (127° C.) and exhibits good ion conducting properties in a hexagonal structure that is a high-temperature phase.

The temperature of the heat treatment is, for example, 50° C. or more, may be 75° C. or more, or may be 100° C. or more. On the other hand, the temperature of the heat treatment is 190° C. or less, may be 160° C. or less, or may be 150° C. or less.

The time of the heat treatment is not particularly limited, and can be appropriately adjusted according to the temperature of the heat treatment. The time of the heat treatment is, for example, 30 minutes or more and 4 hours or less.

### 4. Sulfide Solid Electrolyte

The sulfide solid electrolyte produced by the above process is the same as the content described in “A. Sulfide Solid Electrolyte”, and therefore the description thereof will be omitted.

### C. All-Solid-State Battery

The sulfide solid electrolyte in the present disclosure is used in an all-solid-state battery. That is, the all-solid-state battery of the present disclosure includes a positive electrode active material layer, a negative electrode active material layer, and a solid electrolyte layer disposed between the positive electrode active material layer and the negative electrode active material layer. At least one of the positive electrode active material layer, the negative electrode active material layer, and the solid electrolyte layer contains the sulfide solid electrolyte described above.

In the all-solid-state battery according to the present disclosure, at least one of the positive electrode active material layer, the negative electrode active material layer, and the solid electrolyte layer contains the sulfide solid electrolyte described above, so that the all-solid-state battery has a good discharge capacity retention ratio.

FIG. 2 is a schematic cross-sectional view illustrating an all-solid-state battery according to the present disclosure. The all-solid-state battery 10 shown in FIG. 2 includes a positive electrode active material layer 1, a negative electrode active material layer 2, and a solid electrolyte layer 3 disposed between the positive electrode active material layer 1 and the negative electrode active material layer 2. The all-solid-state battery 10 includes a positive electrode current collector 4 that collects electrons of the positive electrode active material layer 1 and a negative electrode current collector 5 that collects electrons of the negative electrode active material layer 2. At least one of the positive electrode active material layer 1, the negative electrode active material layer 2, and the solid electrolyte layer 3 contains the sulfide solid electrolyte described above.

### 1. Positive Electrode Active Material Layer

The positive electrode active material layer contains at least a positive electrode active material. The positive electrode active material layer preferably contains at least one of a solid electrolyte, a conductive material, and a binder, as necessary. Examples of the positive electrode active material, the conductive material, and the binder include conventionally known materials. The positive electrode active material layer preferably contains the above sulfide solid electrolyte as a solid electrolyte.

### 2. Negative Electrode Active Material Layer

The negative electrode active material layer contains at least a negative electrode active material. The negative electrode active material layer preferably contains at least one of a solid electrolyte, a conductive material, and a binder, as necessary. Examples of the negative electrode active material, the conductive material, and the binder include conventionally known materials. The negative electrode active material layer preferably contains the above-described sulfide solid electrolyte as a solid electrolyte.

### 3. Solid Active Material Layer

The solid electrolyte layer contains at least a solid electrolyte, and may optionally contain a binder. The binder is as described above. The solid electrolyte is preferably the sulfide solid electrolyte described above.

### 4. Positive Electrode Current Collector and Negative Electrode Current Collector

The materials of the positive electrode current collector and the negative electrode current collector may be conventionally known metallic materials such as A1, SUS, Cu and Ni.

### 5. All-Solid-State Battery

The all-solid-state battery in the present disclosure is typically a lithium-ion secondary battery. Applications of the all-solid-state battery include, for example, power supplies for vehicles such as hybrid electric vehicle (HEV), plug-in hybrid electric vehicle (PHEV), battery electric vehicle (BEV), gasoline-powered vehicles, and diesel-powered vehicles. The all-solid-state battery is particularly preferably used as a driving power supply for a hybrid electric vehicle (HEV), a plug-in hybrid electric vehicle (PHEV), or a battery electric vehicle (BEV). The all-solid-state battery may be used as a power source for a moving object other than a vehicle (e.g., a railway, a ship, or an aircraft), or may be used as a power source for an electric product such as an information processing device.

Note that the present disclosure is not limited to the above-described embodiment. The above embodiment is an example. Any device having substantially the same configuration as the technical idea described in the claims in the present disclosure and having the same operation and effect is included in the technical scope of the present disclosure.

### Example 1-1

Li₂S (made by Mitsuwa Chemical Co., Ltd.) and P₂S₅ (made by Merck Co., Ltd.) were prepared to have a molar ratio of 75:25 as a raw material. These were subjected to dry mechanical milling under the following conditions to obtain a first sulfide glass (0.75Li₂S·0.25P₂S₅): ball diameter: 5 mm, container: 80 mL, number of revolutions: 510 rpm, and operation time: 10 hours (first mechanical milling step). LiBH₄ (made by Aldrich) was added to the first sulfide glass at the molar ratio of the first sulfide glass to LiBH₄ of 48:52, and the resultant mixture was subjected to dry mechanical milling (ball diameter: 5 mm, container: 80 mL, number of revolutions: 510 rpm, operation time: 15 hours) (second mechanical milling step). This gave a sulfide solid electrolyte (second sulfide glass) having a 48(0.75Li₂S·0.25P₂S₅)·52LiBH₄. The above composition corresponds to a composition of (100−x)[yLi₂S·(1−y)P₂S₅]·xLiBH₄ when x=52 and y=0.75. As a mechanical milling device, a planetary ball mill premium line PL-7 manufactured by Fritsch was used.

In the mechanical milling device, the revolution radius rs was 0.07 m, the radius rp1 of the container was 0.0240 m, and the rotation-to-revolution ratio iw was −2.0. The gravity Gn1 obtained by substituting these values and the number of revolutions in the expression (1) was 18 G in both the first mechanical milling step and the second mechanical milling step.

### Examples 1-2 to 1-5 and Comparative Examples 1-1 to 1-7

The sulfide solid electrolyte was produced in the same manner as in Example 1-1 except that the ratio among Li₂S, P₂S₅, and LiBH₄ was changed so that the composition of the sulfide solid electrolyte had the values in Table 1.

### Evaluation 1

### Measurement of Ionic Conductivity

The sulfide solids electrolytes of Examples 1-1 to 1-5 and Comparative Examples 1-1 to 1-7 were weighed from 0.08 g to 0.1 g and pressed and pelletized under 6 t pressure. Impedance measurements were then made at 25° C. Using the obtained resistivity R (Ω), the thickness L of the pellet (cm), and the bottom area A of the pellet (cm²), the ionic conductivity (σ) was calculated from the following expression. The results are in FIG. 3 and Tables 1.

$$σ = L / ( RA )$$

TABLE 1

| | | | Ionic |
|---|---|---|---|
| | (100 − x)[yLi₂S · (1 − y)P₂S₅] · xLiBH₄ | | conductivity |
| | x | y | (mS/cm) |
| Example 1-1 | 52 | 0.75 | 8.2 |
| Example 1-2 | 57 | | 9.3 |
| Example 1-3 | 58 | | 9.5 |
| Examples 1-4 | 60 | | 9.9 |
| Example 1-5 | 67 | | 6.7 |
| Comparative | 20 | | 1.0 |
| Example 1-1 | | | |
| Comparative | 33 | | 1.9 |
| Example 1-2 | | | |
| Comparative | 41 | | 3.1 |
| Example 1-3 | | | |
| Comparative | 50 | | 3.5 |
| Example 1-4 | | | |
| Comparative | 75 | | 3.8 |
| Example 1-5 | | | |
| Comparative | 80 | | 2.1 |
| Example 1-6 | | | |
| Comparative | 83 | | 1.6 |
| Example 1-7 | | | |

As shown in FIG. 3 and Table 1, it was confirmed that there was a peak in ionic conductivity and a good ionic conductivity (5.0 ms/cm or more) was exhibited at 50<x<75.

### X-Ray Diffraction Measurement

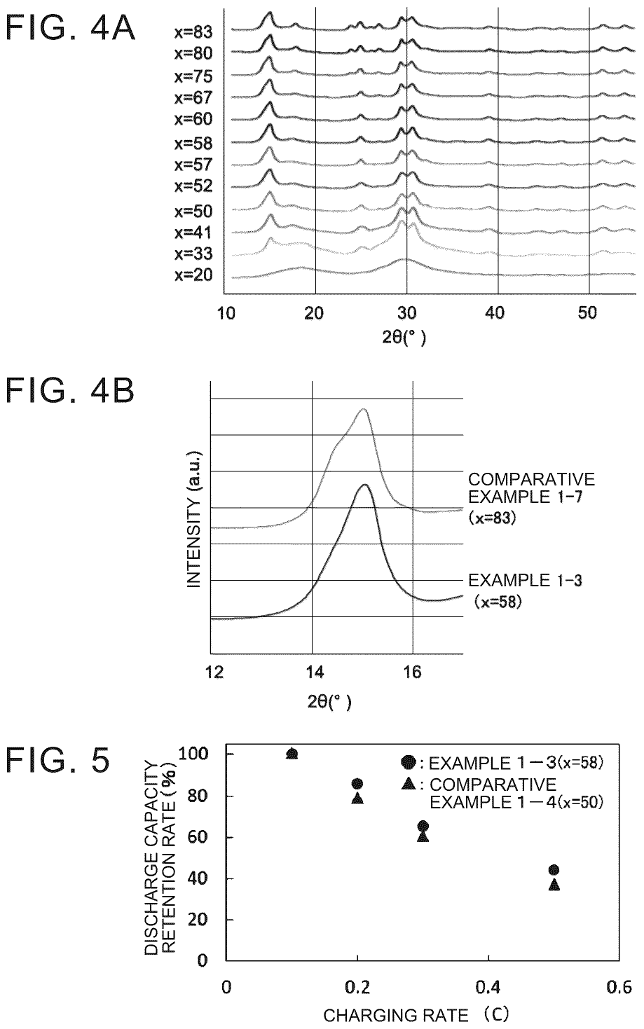

The sulfide solid electrolytes of Examples 1-1 to 1-5 and Comparative Examples 1-1 to 1-7 were subjected to X-ray diffractometry under Ar conditions at room temperature. The apparatus was a fully automated multi-purpose X-ray diffractometer SmartLab manufactured by Rigaku Corporation, and the X-rays were CuKα rays (λ=1.5404 Å). The results are shown in FIG. 4A and FIG. 4B. FIG. 4B is an enlarged view obtained by extracting Example 1-3 (x=58) and Comparative Example 1-7 (x=83) in FIG. 4A.

As shown in FIG. 4A, when x is too low, no peak was confirmed in the range where 2θ is 13° or more and 16° or less. As shown in FIG. 4B, in Example 1-3, there was one peak in the range where 2θ is 13° or more and 16° or less, but in Comparative Example 1-7, two peaks including the shoulder were confirmed. Although not shown, two peaks were confirmed in the other comparative examples as in Comparative Example 1-7.

### (Measurement of Discharge Capacity Retention Rate)

Using the sulfide solid electrolytes of Examples 1-3 and Comparative Examples 1-4, evaluation batteries were prepared as follows. First, the sulfide solid electrolyte was atomized by mechanical milling in a mixed solvent of heptane and dibutyl ether. The atomized sulfide solid electrolyte was then dried at 100° C. for 2 hours. Then, the dried sulfide solid electrolyte was mixed with spherical graphite in a volume ratio of 35:65 to prepare a negative electrode mixture. The negative electrode mixture, the separator layers, and the counter electrode (Li—In foil) were laminated in this order. Thus, an evaluation battery (negative electrode half-cell) was produced. Note that a sulfide solid electrolyte (second sulfide glass) after the second mechanical milling step was used as the separator layer.

CCCV charge/discharge of 0.1 C was performed at 25° C. for three cycles for each of the obtained cells. In CCCV charging/discharging, the cutoff voltage was 0.05 V (Li⁺/Li) and the cutoff current was 0.01 C. Thereafter, the charge rate was changed from 0.1 to 0.5 C, and the discharge rate was fixed by 0.1 C, and CC charging and discharging were performed. Note that the cutoff voltage in CC charging and discharging is 0.05 V (Li⁺/Li). The capacity in CC charge/discharge was divided by the initial capacity, and the discharge capacity retention ratio (%) was calculated. The results are shown in FIG. 5.

As shown in FIG. 5, the charge-discharge capacity in Example 1-3 was larger than that in Comparative Example 1-4 as the charge rate was higher. In particular, when the charge rate was 0.5 C, the capacity retention ratio of Example 1-3 was 1.2 times higher than that of Comparative Example 1-4.

### Example 2-1

The sulfide solid electrolyte was prepared in the same manner as in Example 1-1 except that the ratio among Li₂S, P₂S₅, and LiBH₄ was changed so that the sulfide solid electrolyte had a composition of 46 (0.75Li₂S·0.25P₂S₅)·54LiBH₄. The above composition corresponds to the composition of (100−x)[yLi₂S·(1−y)P₂S₅]·xLiBH₄ when x=54 and y=0.75.

### Comparative Example 2-1

In the first mechanical milling step, a sulfide solid electrolyte was prepared in the same manner as in Example 2-1, except that the ball diameter was 4 mm and the number of revolutions was 280 rpm, the gravity Gn1 obtained from the expression (1) was changed to 5.4 G, and the operation time was changed to 45 hours.

### Evaluation 2

### Measurement of Ionic Conductivity

The ionic conductivities of the sulfide solid electrolytes of Example 2-1 and Comparative Example 2-1 was measured in the same manner as in Evaluation 1. The results are shown in Table 2.

TABLE 2

| | Gn1 (G) | | |
|---|---|---|---|
| | First mechanical | Second mechanical | Ionic conductivity |
| | milling step | milling step | (mS/cm) |
| Example 2-1 | 18 | 18 | 8.7 |
| Comparative | 5.4 | 18 | 4.0 |
| Example 2-1 | | | |

As shown in Table 2, in the first mechanical milling step and the second mechanical milling step, by performing mechanical milling so that Gn1 is equal to or higher than 6 G, it was confirmed that the ionic conductivity is better. This is presumed to be because Li₃PS₄ skeleton was formed better.

### Example 3-1

In the same manner as in Example 1-3, a sulfide solid electrolyte (sulfide glass) having a 42(0.75Li₂S·0.25P₂S₅)·58LiBH₄ was obtained. The resulting sulfide glass was heated at a temperature of 60° C. for two hours. The sulfide solid electrolyte after heating was used as an evaluation sample.

### Examples 3-2 to 3-4

A sulfide solid electrolyte (evaluation sample) was obtained in the same manner as in Example 3-1 except that the heat treatment temperature was changed as shown in Table 3.

### Evaluation 3

### Measurement of Ionic Conductivity

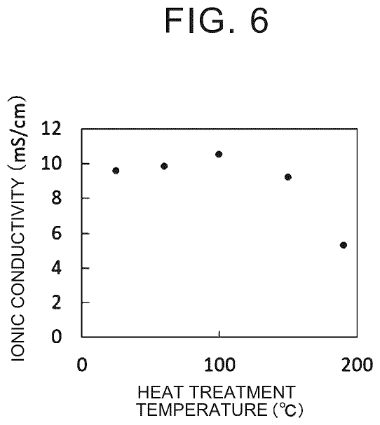

The ionic conductivity of the sulfide solid electrolytes of Examples 3-1 to 3-4 was measured in the same manner as in Evaluation 1. The measurement results for Examples 3-1 to 3-4 together with the results for Example 1-3 are shown in Table 3 and FIG. 6. Although it can be considered that the heat treatment was not performed in Example 1-3, for convenience, the heat treatment temperature was described as room temperature (25° C.).

TABLE 3

| | | | Heat | |
|---|---|---|---|---|
| | (100 − x)[yLi₂S · (1 − y)P₂S₅] · | | treatment | Ionic |
| | xLiBH₄ | | temperature | conductivity |
| | x | y | (° C.) | (mS/cm) |
| Example | 58 | 0.75 | 25 | 9.5 |
| 1-3 | | | | |
| Example | | | 60 | 9.9 |
| 3-1 | | | | |
| Example | | | 100 | 10.5 |
| 3-2 | | | | |
| Example | | | 150 | 9.2 |
| 3-3 | | | | |
| Example | | | 190 | 5.3 |
| 3-4 | | | | |

As shown in FIG. 6 and Table 3, it was confirmed that good ionic conductivity can be obtained by heat treatment at 190° C. or less, and it was confirmed that ionic conductivity is further improved by heat treatment at 160° C. or less. In addition, the ionic conductivity was highest when heat treatment was performed at 100° C. The hydride (LiBH₄) used in the disclosed sulfide solid electrolyte undergoes a phase transition in the vicinity of 400 K (127° C.). It is known that the ion conducting properties of LiBH₄ are improved as LiBH₄ changes from an orthorhombic structure which is a low-temperature phase to a hexagonal structure which is a high-temperature phase. Therefore, it is presumed that even in the sulfide solid electrolyte using LiBH₄, the ionic conductivity is highest in the heat treatment at 100° C. near the phase transition temperature. In addition, in the sulfide solid electrolyte using LiBH₄, it is presumed that the glass-ceramics were favorably formed by the heat treatment at around 100° C. and the ionic conductivity was favorable.

What is claimed is:

1. A sulfide solid electrolyte for use in an all-solid-state battery, the sulfide solid electrolyte having a composition represented by
(100−x)[yLi₂S·(1−y)P₂S₅]·xLiBH₄,
where x satisfies 50<x<75, and y satisfies 0.72≤y≤0.78, and
an ionic conductivity of the sulfide solid electrolyte at 25° C. is 5.0 mS/cm or more.

2. The sulfide solid electrolyte according to claim 1, wherein the ionic conductivity is 8.0 mS/cm or more.

3. The sulfide solid electrolyte according to claim 1, wherein in an X-ray diffraction measurement using a CuKα ray, the sulfide solid electrolyte has one peak in a range where 2θ is 13° or more and 16° or less.

4. A method for producing the sulfide solid electrolyte according to claim 1, the method comprising:
a first mechanical milling step of mechanically milling a mixture containing Li₂S and P₂S₅ to obtain a first sulfide glass; and
a second mechanical milling step of adding LiBH₄ to the first sulfide glass and mechanically milling a mixture of the first sulfide glass and LiBH₄ to obtain a second sulfide glass, wherein in the first mechanical milling step and the second mechanical milling step, the mechanical milling is performed in such a manner that gravity Gn1 calculated by the following expression (1) is equal to or greater than 6 G:
$$Gn 1 = [ rs - \{ rp 1 \cdot 〈 \frac{rp 1}{rs} \cdot {( 1 + iw )}^{2} 〉 \} ] \cdot \frac{{( 2 \cdot π \cdot \frac{rpm}{60} )}^{2}}{9.81} \qquad ( 1 )$$
where rs represents a revolution radius, rp1 represents a radius of a container used in the mechanical milling, iw represents a rotation-to-revolution ratio, x represents a ratio of a circumference of a circle to a diameter of the circle, and rpm represents a number of revolutions per minute.

5. The method according to claim 4, wherein the gravity Gn1 is equal to or greater than 15 G.

6. The method according to claim 4, further comprising a heat treatment step of heat treating the sulfide glass, wherein a temperature of the heat treatment is 190° C. or less.

7. An all-solid-state battery including a positive electrode active material layer, a negative electrode active material layer, and a solid electrolyte layer disposed between the positive electrode active material layer and the negative electrode active material layer, at least one of the following layers containing the sulfide solid electrolyte according to claim 1: the positive electrode active material layer, the negative electrode active material layer, and the solid electrolyte layer.
